(19) United States
(12) Patent Application Publication
(10) Pub. No.: US 2026/0365136 A1
(43) Pub. Date: Nov. 19, 2026

(54) LINK LOCKING DEVICE OF VEHICLE SEAT

(71) Applicant: DAS CO., LTD, Gyeongju-si (KR)

(72) Inventor: Sang Ok PARK, Yongin-si (KR)

(21) Appl. No.: 19/751,907

(22) Filed: Jul. 23, 2026

Related U.S. Application Data
(63) Continuation of application No. 18/396,089, filed on Dec. 26, 2023.

(30) Foreign Application Priority Data
Aug. 11, 2023 (KR) 10-2023-0153753

(51) Int. Cl. B60R 22/26; B60R 22/18

(52) U.S. Cl. CPC B60R 22/26; B60R 2022/1806

(57) ABSTRACT

The present invention relates to a link locking device of a vehicle seat configured to prevent a force exerted on a seat belt from causing a height link to rotate through a buckle. The device includes a sector gear unit rotatably fastened to a cushion frame and fastened to a link connection unit to which a height link provided in a seat rail is rotatably coupled and a locking unit rotatably coupled to the cushion frame and fastened to a buckle of a seat belt to engage the sector gear unit and block the rotation of the link connection unit when the buckle is pulled. In this configuration, when the buckle is pulled, the locking unit engages the sector gear unit to restrain the link connection unit from rotating to prevent the rotation of the height link, thereby having the effect of preventing the distortion of the seat cushion.

### CROSS-REFERENCE TO RELATED APPLICATION

The present application claims priority to Korean Patent Application No. 10-2023-0153753, filed Nov 08, 2023, the entire contents of which is incorporated herein for all purposes by this reference.

### BACKGROUND OF THE INVENTION

### Field of the Invention

The present invention relates to a link locking device of a vehicle seat, and more particularly to a link locking device of a vehicle seat configured to prevent a force exerted on a seat belt from causing a height link to rotate through a buckle.

### Description of the Related Art

In general, vehicle seats are equipped with various convenience features for the comfort of passengers.

The convenience features include a sliding function that allows forward and backward adjustment of a seat cushion according to the passenger’s body shape, a reclining function that allows tilt adjustment of a seatback corresponding to the backrest, and a seat height adjustment function that allows height adjustment of the seat cushion to fit the passenger’s body size.

In addition, the seats are equipped with seat belts for passenger safety, and a buckle for fastening the seat belt is affixed to the upper rail at the top by a separate connecting member and connecting bracket on one side of the seat.

In such a conventional structure, it is possible to support the seat belt even under strong collision loads as long as the separation strength between the upper rail and the lower rail affixed to the vehicle body was sufficient. However, since the buckle for affixing the seat belt is mounted on the rail affixed to the vehicle body, the buckle protrudes excessively when the cushion is adjusted to the lowest position while the buckle is concealed under the cushion when the cushion is adjusted to the highest position.

To address this issue, the buckle was mounted on the seat base rather than the upper rail as in the conventional design so that the buckle could remain in the same position when the base moves according to the height adjustment.

However, when a vehicle equipped with a buckle affixed to the seat base through a connecting bracket is involved in a collision, the force propelling the passenger forward is exerted on the seat belt, the force exerted on the seat belt is transmitted to the buckle, a strong rotational force is transmitted to the height link as the side frame coupled to the buckle is lifted by the force pulling the buckle, and consequently, the buckle side link without a rotation prevention device of the link rotates under the intense load to distort the seat cushion. As a result, the support member in the cushion is damaged, and the support necessary for preventing forward movement and sagging of the cushion is compromised.

Therefore, there is a need to develop a device that restrains the rotation of the link to prevent the impact load of the buckle from causing the buckle side height link to rotate when a strong impact load is applied due to a collision.

### Document of Related Art

(Patent Document) Japanese Laid-open Patent Application 2011-037407 (February 24, 2011)

### SUMMARY OF THE INVENTION

The present invention is designed to address the issue described above, and an object of the present invention is to provide a link locking device of a vehicle seat configured to prevent a force exerted on a seat belt from causing a height link to rotate through a buckle.

To achieve the object described above, a link locking device of a vehicle seat according to a preferred embodiment of the present invention includes a sector gear unit rotatably fastened to a cushion frame and fastened to a link connection unit to which a height link provided in a seat rail is rotatably coupled and a locking unit rotatably coupled to the cushion frame and fastened to a buckle of a seat belt to engage the sector gear unit and block the rotation of the link connection unit when the buckle is pulled.

Here, the sector gear unit may include a sector gear unit main body fastened to the link connection unit between the cushion frame and the height link and a sector gear formed from the sector gear unit main body toward the locking unit.

The locking unit may include a base frame fastened to the cushion frame, a rotating member rotatably fastened to the base frame and including a pawl gear to engage the sector gear unit, and a guide link rotatably fastened to the base frame and having one side fastened to the buckle to receive the rotational power and the other side rotating the rotating member to engage the pawl gear with the sector gear unit.

In addition, the locking unit may include a buckle shaft positioned through slot holes formed in the base frame and the cushion frame and having one end fastened to the buckle and the other end rotatably fastened to one side of the guide link.

Further, the locking unit may include a torsion spring having one end fastened to the rotating member and the other end fastened to the base frame to apply an elastic force to cause the rotating member to rotate in a direction the pawl gear pulls away from the sector gear unit.

The rotating member may include a support boss protruding away from the sector gear unit and seated on a pressing boss protruding from the other side of the guide link to receive rotational power.

In addition, the base frame may include a rotating member hinge portion rotatably fastened to the rotating member and a guide link hinge portion to which the guide link is rotatably fastened.

### BRIEF DESCRIPTION OF THE DRAWINGS

FIG. 1 is a perspective view schematically illustrating a link locking device of a vehicle seat installed in a seat according to an embodiment of the present invention.

FIG. 2 is an exploded perspective view schematically illustrating a link locking device of a vehicle seat detached from a seat according to an embodiment of the present invention.

FIG. 3 is a perspective view schematically illustrating a link locking device of a vehicle seat according to an embodiment of the present invention.

FIG. 4 is an exploded perspective view schematically illustrating a link locking device of a vehicle seat according to an embodiment of the present invention.

FIG. 5 is a view schematically illustrating a link locking device of a vehicle seat before a buckle is pulled according to an embodiment of the present invention.

FIG. 6 is a view schematically illustrating a link locking device of a vehicle seat when a buckle is pulled according to an embodiment of the present invention.

### DETAILED DESCRIPTION OF THE INVENTION

Preferred embodiments of the present invention will be described in detail with reference to the accompanying diagrams.

The present invention may be diversely modified and may have various embodiments. Certain embodiments will be illustrated in drawings and specifically described in the detailed description below. It is to be understood that the specific embodiments are not intended to limit the present invention thereto and that all modifications, equivalents, or substitutes within the spirit and technical scope of the present invention are included.

The terms used in the present application are used to describe the specific embodiments only and are not intended to limit the present invention. Singular expressions may include plural expressions unless the context expressly means otherwise.

Unless otherwise defined, all terms used herein, including technological or scientific terms, may have the same meaning as the terms commonly understood by those skilled in the art to which the present invention pertains. Terms defined in commonly used dictionaries may be interpreted as having meanings consistent with the contextual meanings of the related technology and may not be interpreted in an idealistic or overly formal sense unless expressly defined in the present specification.

Hereinafter, specific embodiments of the present invention will be described in detail with reference to the accompanying drawings.

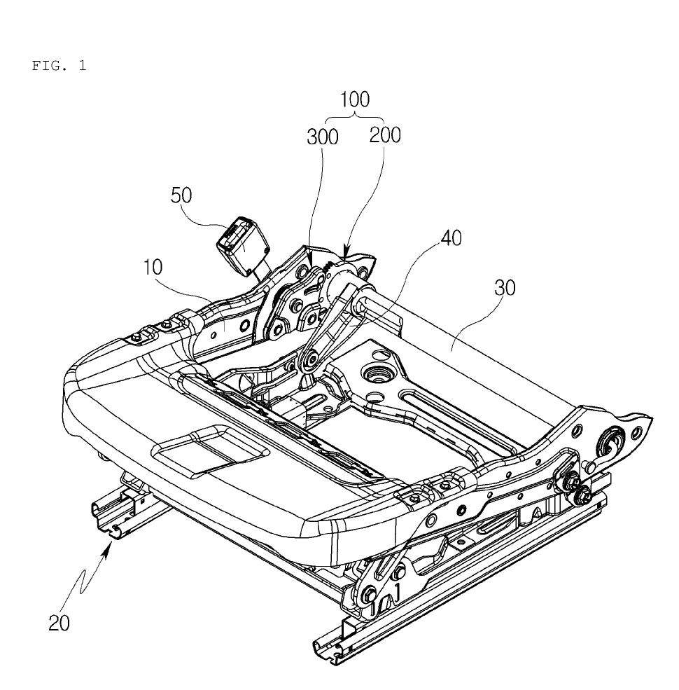

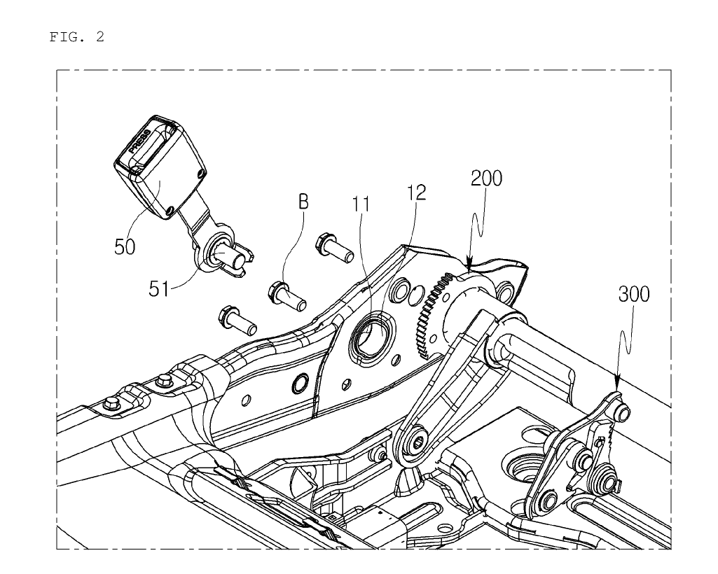

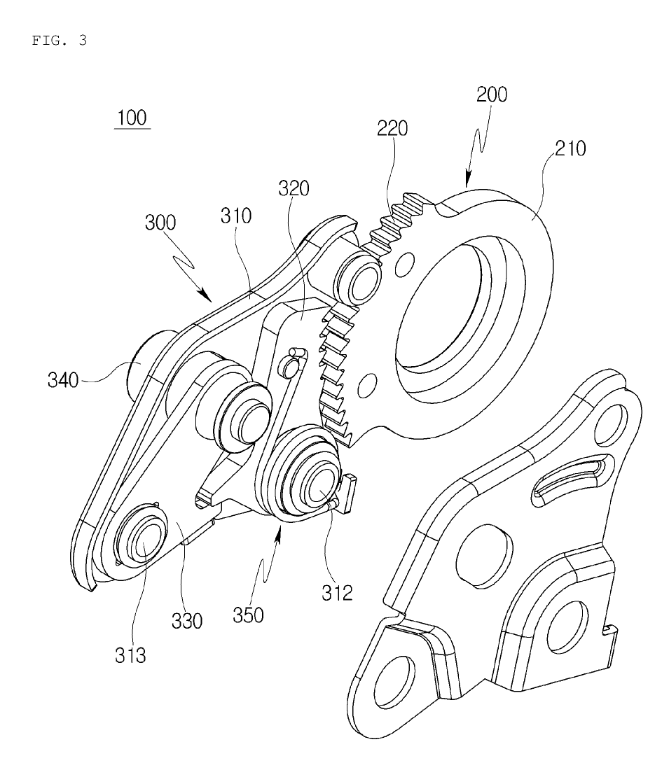

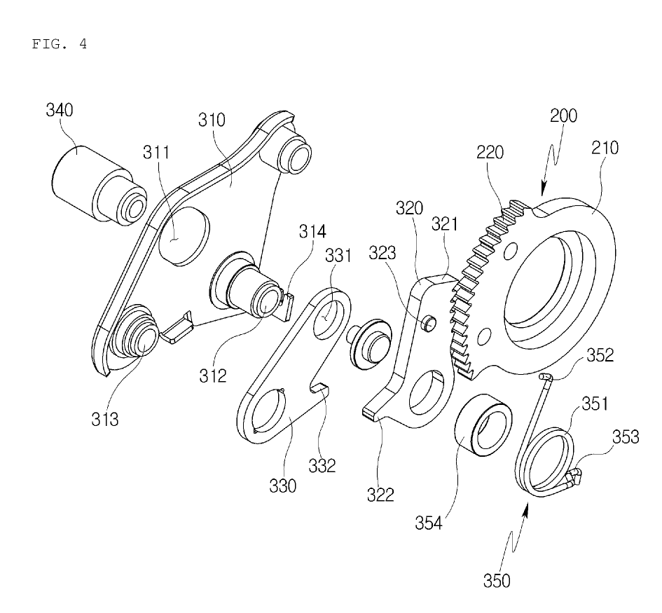

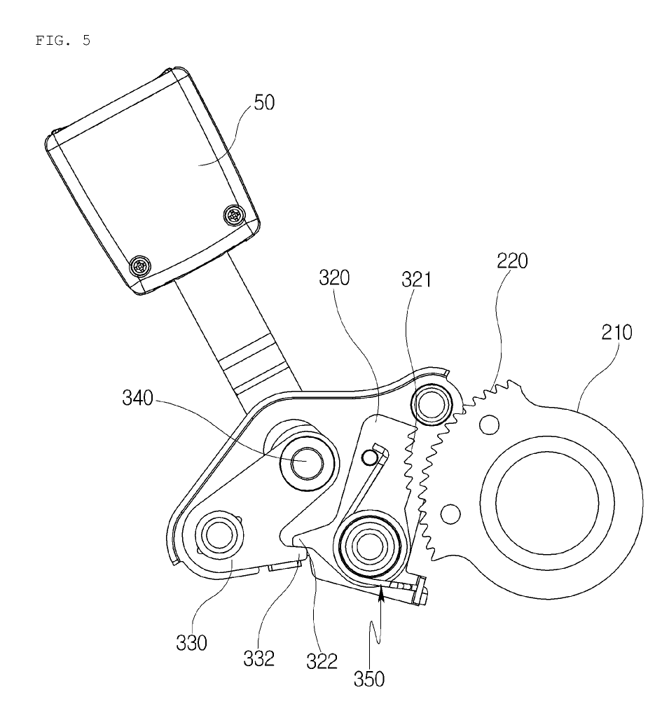

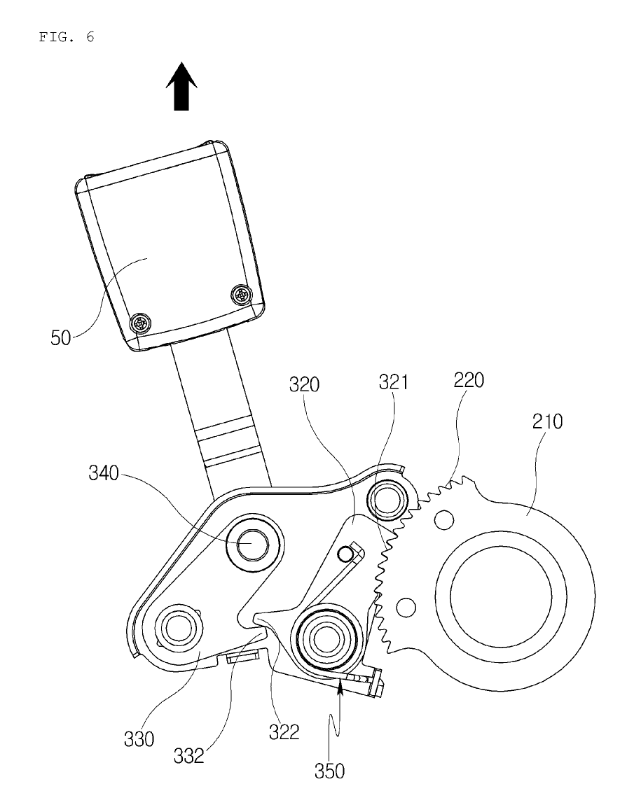

FIGS. 1 and 2 are a perspective view and an exploded perspective view schematically illustrating a link locking device of a vehicle seat installed in a seat according to an embodiment of the present invention; FIGS. 3 and 4 are a perspective view and an exploded perspective view schematically illustrating the link locking device of a vehicle seat; FIGS. 5 and 6 are views schematically illustrating the link locking device for a vehicle before and after a buckle is pulled.

FIGS. 1- 6 show that a link locking device 100 for a vehicle seat according to an embodiment of the present invention includes a sector gear unit 200 rotatably fastened to a cushion frame 10 and fastened to a link connection unit 30 to which a height link 40 provided in a seat rail 20 is rotatably coupled and a locking unit 300 rotatably coupled to the cushion frame 10 and fastened to a buckle 50 of a seat belt to engage the sector gear unit 200 and block the rotation of the link connection unit 30 when the buckle is pulled.

The seat rail 20 is installed on the floor panel inside the vehicle and is equipped to be movable in the forward and backward directions of the vehicle. One side of the height link 40 is rotatably coupled to the rear end of the seat rail 20 while the other side of the height link 40 is rotatably coupled to the link connection unit 30 rotatably fastened to the cushion frame 10. In other words, the height of the cushion frame 10 can be adjusted upward and downward with respect to the seat rail 20, and the link connection unit 30 and the height link 40 rotate when the cushion frame 10 moves.

Therefore, when at least either of the link connection unit 30 and the height link 40 is restrained from rotating, the movement of the cushion frame 10 is restrained and the distortion of the seat cushion may be prevented.

Accordingly, in the present invention, when the buckle 50 is pulled due to a collision, the locking unit 300 engages the sector gear unit 200 to restrain the link connection unit from rotating so that the movement of the cushion frame 10 may be restrained.

To this end, the sector gear unit 200 is fastened to the link connection unit 30 rotatably fastened to the cushion frame 10 and engages the locking unit 300 to restrain the rotation when the buckle 50 is pulled.

More specifically, the sector gear unit 200 includes a sector gear unit main body 210 fastened to the link connection unit 30 between the cushion frame 10 and the height link 40 and a sector gear 220 formed from the sector gear unit main body 210 toward the locking unit 300. Here, the sector gear 220 includes a plurality of sector gear teeths.

The locking unit 300 is rotatably coupled to the cushion frame 10, is fastened to the buckle 50 of the seat belt, and engages the sector gear 220 of the sector gear unit 200 to block the rotation of the link connection unit 30 when the buckle is pulled.

More specifically, the locking unit 300 includes a base frame 310 fastened to the cushion frame 10, a rotating member 320 rotatably fastened to the base frame 310 and including a pawl gear 321 to engage the sector gear unit 200, and a guide link 330 rotatably fastened to the base frame 310 and having one side fastened to the buckle 50 to receive rotational power and the other side rotating the rotating member 320 to engage the pawl gear 321 with the sector gear unit 200.

The locking unit 300 also includes a buckle shaft 340 positioned through the slot holes 11, 311 formed in the base frame 310 and the cushion frame 10 and having one end rotatably fastened to the buckle 500 and the other end rotatably fastened to one side of the guide link 330.

In this configuration, the buckle 50 is positioned on the outside of the cushion frame 10 and the buckle fastening member 51 is fastened to one end of the buckle shaft 340 positioned through both the slot hole 11 formed in the cushion frame 10 and the slot hole 311 formed in the base frame 310 to fasten the buckle 50 to the buckle shaft 340.

This allows the buckle shaft 340 to move upward along the slot holes 11, 311 when the buckle 50 is pulled upward.

Here, the cushion frame 10 may include a guide bushing 12 for guiding the movement of the buckle shaft 340 positioned around the periphery of the slot hole 11. The guide bushing 12 may guide the movement of the buckle shaft 340 and prevent noise caused by the collision between the buckle shaft 340 and the cushion frame 10.

The base frame 310 is fastened to the cushion frame 10 and the slot hole 311 is formed for the buckle shaft 340 to be movably inserted thereinto.

The base frame 310 also includes a rotating member hinge portion 312 to which the rotating member 320 is rotatably fastened and a guide link hinge portion 313 to which the guide link 330 is rotatably fastened.

The base frame 310 is fastened to the cushion frame 10 through a fastening member B, which is a bolt. At this time, a plurality of fastening members is screwed to the rotating member hinge portion 312 and the guide link hinge portion 313 respectively through the cushion frame 10 from the outside of the cushion frame 10 while the base frame 310 is positioned on the inside of the cushion frame 10 to fasten the base frame 310 to the cushion frame 10.

The guide link 330 is inserted and rotatably fastened onto the guide link hinge portion 313 provided in the base frame 310. A buckle shaft 340 is inserted and fastened into a buckle shaft fastening hole 331 formed on one side of the guide link while a pressing boss 332 is formed on the other side to press and rotate the rotating member 320.

The rotating member 320 is inserted and rotatably fastened onto a rotating member hinger portion 312 provided in the base frame 310, includes a pawl gear 321 on a surface facing the sector gear unit 200, and includes a support boss 322 protruding away from the sector gear unit 200 and seated on a pressing boss 332 to receive rotational power.

In this configuration, as illustrated in FIG. 6, when the buckle 50 is pulled, the buckle shaft 340 moves upward to move one side of the guide link 330 upward and rotate the guide link 330 around the guide link hinge portion 313. As a result, the pressing boss 332 moves upward to press the support boss 322 and rotates the rotating member 320 toward the sector gear unit 200 so that the pawl gear 321 engages the sector gear 220.

The locking unit 300 further includes a torsion spring 350 having one end fastened to the rotating member 320 and the other end fastened to the base frame 310 to apply an elastic force to cause the rotating member 320 to rotate in the direction the pawl gear 321 pulls away from the sector gear unit 200.

In other words, the torsion spring 350 includes a ring-shaped spring body 351 inserted and fastened onto the rotating member hinge portion 312 on the outside of the rotating member 320, and one end 352 of the torsion spring 350 catches on and is supported by a fastening hinge 323 protruding from the rotating member 320 while the other end 353 of the torsion spring 350 catches on and is supported by a spring support portion 314 bent to the outside of the base frame 310.

Here, a spring guide bushing 354 having an inner circumferential surface inserted onto the rotating member hinge portion 312 and an outer circumferential surface inserted into the spring body 351 may be further included to fasten and support the torsion spring 350 more stably.

In this configuration, as illustrated in FIG. 6, when the buckle 50 is pulled, the rotating member 320 rotates to engage the pawl gear 321 with the sector gear 220 and compress the torsion spring 350.

When the force pulling the buckle 50 is removed, the elastic force of the torsion spring 350 causes the rotating member 320 to return to its original position so that the pawl gear 321 is detached from the sector gear 220 to return to its original position as illustrated in FIG. 5.

According to the link locking device of a vehicle seat of the present invention, when the buckle is pulled, the locking unit engages the sector gear unit to restrain the link connection unit from rotating and prevent the rotation of the height link, thereby having the effect of preventing the distortion of the seat cushion.

The present invention is described in detail through specific embodiments above. However, this is intended to serve the purpose of specifically describing the present invention, and it is evident that the present invention is not limited thereto and may be modified and improved upon by those skilled in the art within the technical spirit of the present invention.

All simple modifications and changes of the present invention fall within the scope of the present invention, and the specific scope of protection of the present invention will be made clear by the appended patent claims.

### DESCRIPTION OF REFERENCE NUMERALS

10: cushion frame
20: seat rail
30: link connection unit
40: height link
50: buckle
100: link locking device for vehicle seat
200: sector gear unit
210: sector gear unit main body
220: sector gear
300: locking unit
310: base frame
312: rotating member hinge portion
313: guide link hinge portion
314: spring support portion
320: rotating member
321: pawl gear
322: support boss
330: guide link
332: pressing boss
340: buckle shaft
350: torsion spring

What is claimed is:

1. A link locking device of a vehicle seat, the link locking device comprising:
a sector gear unit fastened to a link connection unit, wherein the link connection unit is rotatably fastened to a cushion frame, and a height link provided on a seat rail is rotatably coupled to the link connection unit; and
a locking unit configured to engage the sector gear unit and to block rotation of the link connection unit when a buckle of a seat belt is pulled,
wherein the locking unit comprises:
a base frame fastened to the cushion frame, the base frame having a first slot hole aligned with a second slot hole formed in the cushion frame, a rotating member hinge portion, and a guide link hinge portion spaced apart from the rotating member hinge portion;
a rotating member rotatably fastened to the rotating member hinge portion, the rotating member having a pawl gear configured to engage the sector gear unit and a support boss protruding in a direction away from the sector gear unit;
a guide link rotatably fastened to the guide link hinge portion, the guide link having a buckle shaft fastening hole formed at a first side thereof and a pressing boss formed at a second side thereof, the support boss being seated on the pressing boss; and
a buckle shaft extending through the first slot hole and the second slot hole, the buckle shaft having a first end fastened to the buckle and a second end rotatably fastened in the buckle shaft fastening hole, and
wherein, when the buckle is pulled, the buckle shaft moves translationally upward along the first slot hole and the second slot hole while rotating relative to the guide link so as to rotate the guide link about the guide link hinge portion, and the pressing boss presses the support boss so as to rotate the rotating member about the rotating member hinge portion such that the pawl gear engages the sector gear unit.

2. The link locking device of claim 1, wherein the rotating member receives a rotational force from the buckle shaft only via the guide link, through contact between the pressing boss and the support boss.

3. The link locking device of claim 1, wherein the sector gear unit comprises:
a sector gear unit main body fastened to the link connection unit between the cushion frame and the height link; and
a sector gear formed on the sector gear unit main body toward the locking unit, the sector gear comprising a plurality of sector gear teeth.

4. The link locking device of claim 1, wherein the locking unit further comprises a torsion spring configured to apply an elastic force to the rotating member in a direction in which the pawl gear moves away from the sector gear unit,
wherein the torsion spring comprises a ring-shaped spring body fitted onto the rotating member hinge portion at an outer side of the rotating member, a first end of the torsion spring being caught on and supported by a fastening hinge protruding from the rotating member, and a second end of the torsion spring being caught on and supported by a spring support portion bent outwardly from the base frame, and
wherein, when a force pulling the buckle is removed, the rotating member is returned to an original position by the elastic force of the torsion spring such that the pawl gear is disengaged from the sector gear unit.

5. The link locking device of claim 4, wherein the locking unit further comprises a spring guide bushing having an inner circumferential surface fitted onto the rotating member hinge portion and an outer circumferential surface inserted into the spring body so as to support the torsion spring.

6. The link locking device of claim 1, wherein the base frame is positioned at an inner side of the cushion frame, and
wherein a plurality of fastening members is screwed to the rotating member hinge portion and the guide link hinge portion, respectively, through the cushion frame from an outer side of the cushion frame so as to fasten the base frame to the cushion frame.

7. The link locking device of claim 1, wherein the cushion frame comprises a guide bushing provided at a periphery of the second slot hole, the guide bushing being configured to guide movement of the buckle shaft and to prevent noise caused by collision between the buckle shaft and the cushion frame.

8. The link locking device of claim 1, wherein the buckle is positioned at an outer side of the cushion frame, and a buckle fastening member is fastened to the first end of the buckle shaft so as to fasten the buckle to the buckle shaft.
